(19) United States
(12) Patent Application Publication
(10) Pub. No.: US 2025/0182459 A1
(43) Pub. Date: Jun. 5, 2025

(54) SYSTEMS AND METHODS FOR COMPUTER VISION BASED SECURITY USING KNOWLEDGE NETWORKS

(71) Applicant: Q2 Software, Inc., Austin, TX (US)

(72) Inventors: Jesse Lee Barbour, Westlake Hills, TX (US); Kelly Tsao, San Antonio, TX (US); Kristi Lynn Voll, Austin, TX (US); Stephen John Zabel, Austin, TX (US)

(21) Appl. No.: 18/960,855

(22) Filed: Nov. 26, 2024

Related U.S. Application Data
(60) Provisional application No. 63/605,324, filed on Dec. 1, 2023.

(51) Int. Cl. G06V 10/778; G06Q 20/40; G06V 10/764

(52) U.S. Cl. CPC G06V 10/778; G06Q 20/4016; G06V 10/764

(57) ABSTRACT

Systems and methods for computer vision based security using knowledge networks are disclosed. In particular, embodiments as disclosed herein provide computer vision based image anomaly detection using a distributed knowledge network allowing users to submit knowledge data regarding image anomalies to the computer vision based security system. This knowledge data may be utilized to generate classification pipelines utilizing computer vision based machine learning models that can be utilized to make security determinations.

### RELATED APPLICATIONS

This application claims the benefit of priority under 35 U.S.C. § 119 to U.S. Provisional Application No. 63/605,324, entitled “COMPUTER VISION BASED FRAUD DETECTION USING EXPERT NETWORKS,” filed Dec. 1, 2023, which is hereby fully incorporated by reference herein for all purposes.

### TECHNICAL FIELD

This disclosure relates generally to computer security. In particular, embodiments of this disclosure relate to computer vision based anomaly detection. Even more particularly, embodiments of this disclosure relate to machine learning based anomaly detection using computer vision. Specifically, embodiments of this disclosure relate to the use and implementation of knowledge networks in the training of machine learning models used for computer vision based anomaly detection.

### BACKGROUND

In many domains, processes have arisen that require a human with some form of knowledge or involvement in a particular field (referred to without loss of generality as an expert) to perform visual analysis on an image. These problems, for the most part, relate to detection of a particular feature in an image. To streamline this type of analysis, computer vision systems have been implemented.

These computer vision systems, however, suffer from a number of problems. Usually these computer systems rely on a knowledge base of some type to bootstrap or train the computer system. One of the main problems with implementing these computer systems may thus be how these knowledge bases may be created, updated or maintained.

Other problems also exist with respect to current computer vision based systems. In particular, these computer vision based systems may be implemented in a manner inadequate to perform certain tasks with high enough quality or precision to actually use such computer vision based systems in a real-world environment, especially in the context of performing anomaly detection in images for computer security. Specifically, these systems may be architected to build and utilize large monolithic models for detecting various types of anomalies in images. These monolithic models are difficult to train, and such training may be time and resource intensive. Moreover, a large monolithic model may be less than effective across the range of tasks it may be required to perform.

What is desired then, are improved computer vision based security systems.

### SUMMARY

As discussed, processes have arisen in many areas that require a human with some form of knowledge or involvement in a particular field to perform visual analysis on an image (or series of images or a video) in order to determine or solve a problem. These problems, for the most part, relate to detection of a particular feature in an electronic image. In many cases, this feature indicates an anomaly (e.g., problem) of some type (n.b., an anomaly will be understood herein to mean feature, and may be used interchangeably with the term feature without loss of generality). Accordingly, this type of image analysis may be related, for example, to security, quality control in product manufacturing, analysis of medical imaging, plant or wildlife identification, etc.

To streamline this type of analysis, computer vision systems have been implemented. These computer vision systems, however, suffer from a number of problems. Usually these computer systems rely on a knowledge base of some type to bootstrap or train the computer system. One of the main problems with implementing these computer systems may thus be how to properly determine, prepare, or update a knowledge base for these computer systems that allow computer vision based systems to effectively leverage this knowledge base to perform computer vision based anomaly detection.

To illustrate, there may exist a large number of experts in a particular field that have a significant amount of knowledge in performing such visual analysis. It is difficult, however, to capture and collate such expert knowledge in a knowledge base, and more particularly to capture and collate such data in a form that is suitable for training these types of computer vision systems.

As an initial hurdle, these experts may be widely distributed. This geographical distribution may be especially problematic in scenarios where it is desired to rapidly disseminate this expert knowledge to the users of these computer vision based systems. As but one example, in the context of computer security, malicious actors may rapidly alter their modus operandi in response to detection or increased security measures. Similarly, once a fraud technique has proved effective this technique may rapidly propagate to other malicious actors or across a computer network (e.g., malicious actors may try the same technique in other venues). A significant issue thus arises, how can new knowledge (e.g., security knowledge) be rapidly disseminated and incorporated into security systems such that newly determined knowledge can quickly be leveraged to prevent further malicious acts. Specifically, because of the highly volatile nature of these security systems, when one expert obtains knowledge (e.g., of a particular technique used by a malicious actors or indicators thereof) it is desired to rapidly incorporate this knowledge into computer vision based security systems such that the computer vision based system incorporating this recently acquired knowledge may be deployed in advance of the propagation of the technique to forestall the efficacy of the technique in other settings (e.g., against other potential victims).

A microcosm of these issues occurs with respect to computer security in the context of check deposits and processing. The vast majority of check deposits and processing is now done electronically. Fraud is rampant in this context. In particular, as consumers and businesses quickly adopt new technologies such as Mobile Remote Deposit Capture (mRDC), which enables users to use a digital image to deposit (e.g., paper) checks, bad actors, in turn, move to exploit those new computerized technologies by defrauding legitimate customers. Often, such attacks involve very specific, very subtle, alterations to a check (e.g., an image of a check). Analysts (e.g., at financial institutions) may discover these patterns and features either as a result of their own research or when notified directly by those defrauded. Given the prevalence of mRDC, the amount of data for analysis, as well as the potential for bad actors to quickly collect large amounts of funds, there is an overwhelming need for computer vision based systems that can rapidly incorporate knowledge on newly discovered anomalous features in the context of check deposit and share the information with others, in order to prevent the spread of fraud as quickly and efficiently as possible.

Another significant issue with the generation and use of these knowledge bases, and the use of these knowledge bases for creating computer vision based systems, is that each of the experts that contributes knowledge to such a knowledge base may express (e.g., input) their particular knowledge in a highly individualized manner. For example, when expressing knowledge for a computer vision system each expert may express their knowledge in a different (e.g., natural language) description. It may thus be difficult, if not impossible, to synthesize these differing expressions of expert knowledge into a cohesive and normalized knowledge base that is useful in the context of a computer vision based system.

These difficulties with determining or preparing a knowledge base are part of a more general problem with respect to computer vision based systems. Namely, it has heretofore been the case that computer vision based systems for performing anomaly detection may be architected in a manner that is inadequate to perform such computer vision based tasks with high enough quality or precision to actually use such computer vision based systems to perform this type of analysis in a real-world environment, especially in the context of performing anomaly detection in images for computer security.

Specifically, these systems may build and utilize large monolithic models for detecting various types of anomalies in images. These monolithic models are both difficult to train, and while broadly applicable to many detecting many different kinds of anomalies may be less accurate across these different kinds of image anomalies. Moreover, because of their size, the training time for these models may be extremely long, severely impeding the ability of these monolithic models to be agile enough to rapidly incorporate newly acquired knowledge, as the incorporation of this new knowledge into such a model may require the retraining of the entire model, regardless of the type of anomaly to which that newly acquired knowledge data may apply.

What is desired then, are computer vision based systems and methods that allow the easy and rapid collection of data regarding anomalies, the generation of effective models for computer vision based anomaly detection, and the simple and quick incorporation of such data, including newly acquired data, into the computer vision based models used for anomaly detection in these computer vision based systems.

To address these issues, among others, embodiments as disclosed herein provide computer vision based image anomaly detection using a distributed knowledge network. In particular, systems and methods for a computer vision based security system are disclosed where those computer vision based security systems may be adapted to provide a distributed knowledge network whereby distributed users (e.g., at distributed entities) may submit knowledge data regarding image anomalies to the computer vision based security system.

A user may provide a visual annotation for a submitted image where that visual annotation may comprise a definition of a portion of the image such as the entire image, or a bounding shape indicating a particular portion of the image. Once the particular portion of the image is defined to create the visual annotation, the user may annotate the selected portion with one or more textual annotations describing the user's observations related to the anomaly present in the selected portion. Thus, a knowledge dataset of the computer vision based security system may include a set of data items, where each data item includes a textual annotation and a visual annotation. As embodiments of a computer vision based security system may provide a mechanism through which this anomaly knowledge data may be collected from one or more users at one or more distributed entities or from individual users, data on a wide variety of different anomalies may be collected from a wide variety of geographic areas and from a large number of different users who may have differing and wide ranging expertise.

In some embodiments, the users submitting data to this knowledge network may include a disparate array of (e.g., security) analysts and experts. For example, fraud analysts and experts may be employed by various institutions across the country, or other organizations using documents subject to potentially fraudulent activity. These institutions or other organizations may be very diverse, spanning vastly different markets, geographies, and communities. This diversity provides a multiplicity of broad expertise, advantageously resulting in broad generalization of results.

Further, the knowledge network may provide an aspect of privacy. When users share labeled data in the form of plaintext check images, those images may be accessible only by a single entity: the computer vision based security system. In some embodiments, no other network users are able to access any other participant's data directly, which is advantageous due to the highly sensitive and private nature of data contained on a written check or other document subject to potentially fraudulent activity. Conversely, once a labeled image is received, consumed, and incorporated into the computer vision based security system, the full utility afforded by that labeled image is available to the entire network that may access computer vision based security system, without anyone else ever having accessed the received labeled image itself. This is accomplished by encoding the contents of any labeled image into a machine learning model, the inner workings of which may be inscrutable to any users of computer vision based security systems.

In some embodiments, a set of classification pipelines may be generated based on this collected knowledge dataset. Each classification pipeline may be associated with a particular feature that may be present in an image (e.g., check) and be adapted to determine if an image is anomalous with respect to that feature (e.g., if that feature for that image is indicative of a security violation). Specifically, each of the set of classification pipelines may be generated by training one or more machine learning models based on the knowledge dataset. In one embodiment, each classification pipeline includes a computer vision model trained on the images and visual annotations of the knowledge dataset (or a portion thereof) where the computer vision model for a pipeline may be a classification model adapted to make a classification decision for an image indicating of that image is anomalous with respect to that feature.

Moreover, in some embodiments, a classification pipeline may include a semantic segmentation model adapted to extract a portion of an image corresponding to the feature of that classification pipeline, such that the computer vision model of that classification pipeline may be applied to the (e.g., portion of the) image extracted by the semantic segmentation model of that classification pipeline. This semantic segmentation model may also be trained on the images and visual annotations of the knowledge dataset (or a portion thereof).

In certain embodiments, to train these classification pipelines, the textual annotations for each data point (e.g., an image with a visual annotation and corresponding textual annotation) in the knowledge dataset may be embedded to generate annotation embedding vectors for each of those textual annotation. In this manner, regardless of the language of the textual annotations those textual annotations can be converted to a common representation of the semantics of the topics or concepts of each textual annotation regardless of the language or syntax utilized in the textual annotation.

Once these annotation embedding vectors are generated from the textual annotations, these annotation embedding vectors may be processed to generate a set of clusters of data points (e.g., images and associated annotations) based on the resulting clusters of annotation embedding vectors. Moreover, in some embodiments, textual annotations associated with each of the clusters can be utilized to generate attack vector descriptors associated with each cluster. An attack vector descriptor for a cluster can thus represent the concepts or semantic meanings indicated in the textual annotations associated with that cluster.

In one embodiment, a semantic segmentation model associated with each of the clusters may also be generated, if needed, from the images and visual annotations associated with the data points of a cluster. A semantic segmentation model for a cluster may be adapted to identify and extract a portion of the image corresponding to the cluster. A machine learning (e.g., a classification) model may also be generated for the cluster based on the images and visual annotations associated with the data points of the cluster. This machine learning model classifier may be a computer vision-based classifier (e.g., a neural network) adapted for detecting the presence of the features defined by the images and corresponding visual annotations associated with the cluster.

The semantic segmentation model (if is needed) and (e.g., classification) machine learning model for each cluster may be used to generate a classification pipeline associated with that cluster. Accordingly, each of the generated classification pipelines may be associated with a cluster and include the classifier and any semantic segmentation model associated with that cluster). Additionally, each classification pipeline may be associated with an attack vector descriptor generated based on the data points associated with that same cluster. Thus, notice that the clusters themselves are determined based on canonical representation of the shared meaning across a set of similar, but lexically distinct annotations for a cluster (e.g., the textual annotations associated with data items of the knowledge dataset). The machine learning models associated with a cluster (e.g., the semantic segmentation model or computer vision based machine learning model) are, however, generated based on the image and visual annotations associated with the data items associated with each cluster.

These classification pipelines can then be deployed in, or distributed across, a network for use in detecting anomalies in images, including those indicative of security violations such as fraud. The classification pipelines that are deployed or distributed across the network do not themselves include the images data, thus advantageously providing security violation detection for a broad range of violations, without actual distribution of the submitted images themselves. For example, these classification pipelines may be used to provide real-time fraud detection from a computing device based on an image of a check or other document, using the classifiers to detect features on the completed handwritten check (or other document) that may indicate fraud.

In certain embodiments, as attack vector descriptors are associated with individual classification pipelines, these attack vectors may also serve as a convenient and useful way to associate newly provided knowledge about an anomaly with a classification pipeline in order to retrain that classification pipeline (e.g., while avoiding retraining other classification pipelines). Specifically, attack vector descriptors may be provided to users submitting knowledge data. Thus, a user may utilize these attack vector descriptors to select one or more attack vector descriptors as a textual annotation for an image when submitting this anomaly knowledge data to the computer vision based security system.

Based on the attack vector descriptor included as the textual annotation, the submitted anomaly knowledge data may be associated with the classification pipeline associated with that attack vector descriptor such that the incoming anomaly knowledge data may be used to perform targeted or focused (re)training of the models of only that classification pipeline associated with that attack vector descriptor (e.g., with the end result being a bolstering or supplementation of a known extant vector with additional information). In this manner, only the classification model associated with the attack vector descriptor x included in the anomaly knowledge data may be (re)trained using only that newly submitted anomaly knowledge data. This approach is quite advantageous as it may avoid retraining the other classification pipelines, significantly reducing both the time and computing resources devoted to such training and allowing the newly submitted anomaly knowledge to be rapidly incorporated into the classification pipeline to identify security violations represented by such anomaly data much more rapidly.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure encompasses all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIGS. 1A-1B (collectively FIG. 1) are a block diagram of one embodiment of a computer vision based security system.

FIGS. 2A-2D are examples of images and visual and textual annotations.

FIGS. 3A-3D (collectively FIG. 3) are a block diagram of one embodiment of a pipeline for training a computer vision-based security system.

FIG. 4 is a block diagram of one embodiment of (re)training in a computer vision based security system.

FIG. 5 is a block diagram of one embodiment of making a security violation determination in a computer vision based security system.

FIG. 6 is a flow diagram of one embodiment of a method for training classification pipelines in a computer vision based security system.

FIG. 7 is a flow diagram of one embodiment of a method for (re)training classification pipelines in a computer vision based security system.

FIG. 8 is a flow diagram of one embodiment of a method for making a security violation determination in a computer vision based security system.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

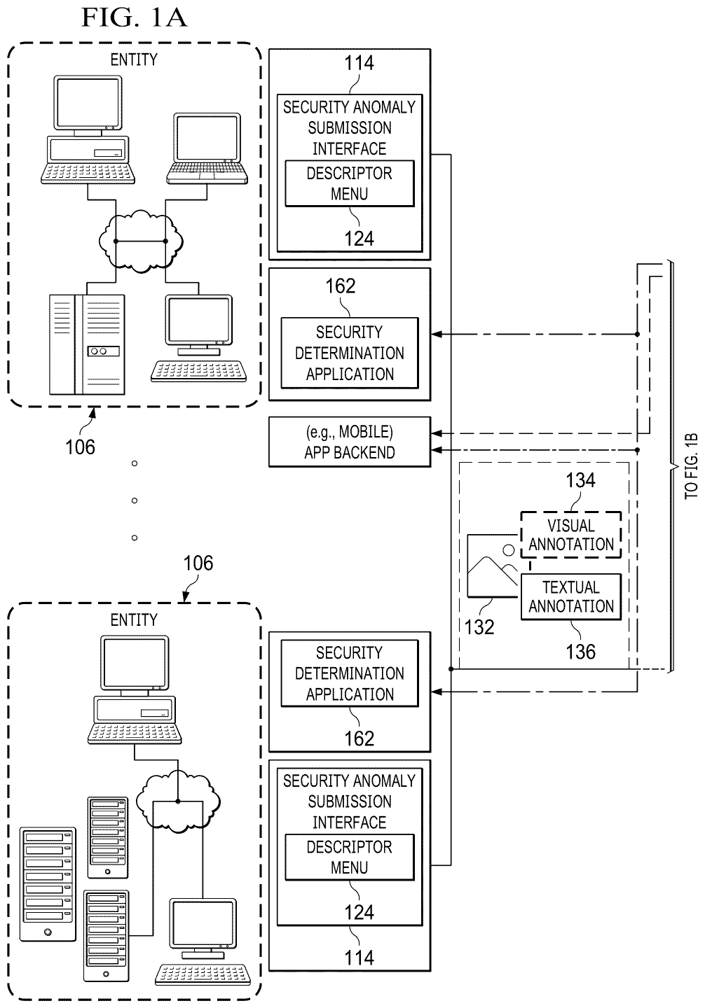

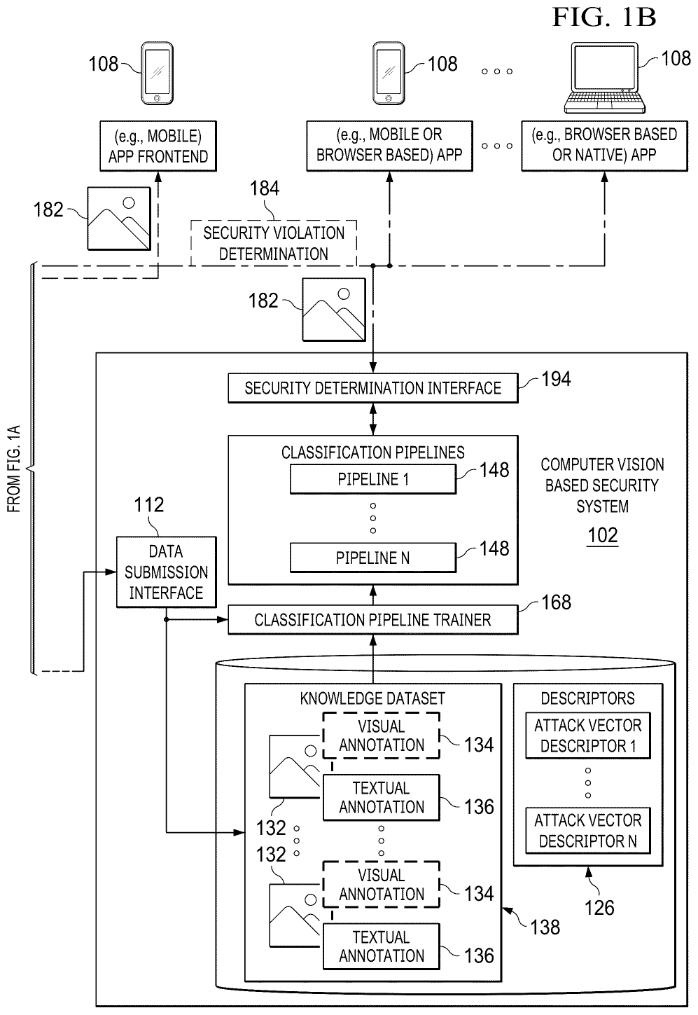

Looking first at FIG. 1, one embodiment of a computer vision based security system 102 is depicted. Computer vision based security system 102 may be utilized by entities 106 or individual users 108. Entities 106 may be any (for profit or non-profit) organization. For example, in the case where computer vision based security system 102 is a security system adapted to be utilized for the determination of image anomalies in check images to determine check fraud, entities 106 may be financial institutions such as banks, credit unions, clearing houses, or other organizations involved with the processing of (e.g., digital images) of checks. Each entity 106 may include a network of computing devices where users may access computer vision based security system 102. This computer network may be a logically or physically distributed network, such that the users at entities 106 may (or may not be) geographically distributed (e.g., an entity 106 may have locations in different geographic locations with portions of that computer network in those different geographic locations).

Computer vision based security system 102 may be adapted to provide a distributed knowledge network whereby users at entities 106 (or individual users 108 at individual user devices) may submit knowledge data to the computer vision based security system 102. In particular, the computer vision based security system 102 may include data submission interface 112 (e.g., an Application Programming Interface (API) or web services interface such as a RESTful interface or the like) through which knowledge data may be submitted. Thus, users at entities 106 (or individual users 108 at their computing devices, such as those with authorization to submit such knowledge data) may access the data submission interface 112 to obtain a security anomaly submission interface 114. This security anomaly submission interface 114 may be a browser based or standalone application that provides an interface for generating a knowledge data submission.

Thus, users at entity 106 or users 108 may use security anomaly submission interface 114 to submit knowledge regarding image anomalies through data submission interface 112 of the computer vision based security system 102. Specifically, using security anomaly submission interface 114 a user may select, or provide, an image (e.g., an image of a check) and generate a textual annotation for a security anomaly included in that image. As understood herein the term image will be understood to mean an electronic image comprising a representation (e.g., of an object) including a set of values for a set of pixels. The textual annotation may include a description that may be as simple as a single-word label or as complex as multi-sentence natural language text, and may describe an anomaly in the (e.g., check) image indicating a security violation, such as a specific kind of font used, an anomaly in the background of the check, an anomaly in the signature of the check (e.g., a reused signatured), an anomaly in an endorsement on a check, etc.

The user may also provide a visual annotation for that image using security anomaly submission interface 114. That visual annotation may comprise a definition of a portion of the image to which a particular textual annotation applies. This visual annotation can, for example, include a bounding shape (e.g., a box, rectangle, circle, etc.) encapsulating a portion of the image associated with a textual annotation. It will be understood that a visual annotation may comprise the entirety of the image, and that a user may not explicitly provide such a visual annotation. In some cases, then, a visual annotation may be a default visual annotation that may comprise the entirety of the image (e.g., when a user provides no visual annotation or no visual annotation for a particular textual annotation).

Thus, users at entity 106 or individual users 108 may utilize their expert knowledge to provide (visual or textual) annotations associated with particular portions (e.g., regions or subregions) of a respective (e.g., check) image based on their observation and analysis of the respective (e.g., check) image. For example, an individual user may select a portion of an image or a check by simply selecting a region (e.g., via click or click-and-drag to select a particular region or via drawing a bounding shape for the region) to create a visual annotation. Once the particular portion of the image is defined to create the visual annotation, the user may annotate the selected portion with one or more textual annotation describing the user's observations related to the anomaly present in the selected portion.

In some embodiments, security anomaly submission interface 114 may provide a descriptor menu 124 that includes a set of attack vector descriptors 126 that a user may utilize when creating a textual annotation. In some cases, these attack vector descriptors 126 may be determined by computer vision based security system 102 from previously submitted anomaly knowledge data as will be discussed elsewhere herein. Thus, when security anomaly submission interface 114 is provided or otherwise generated for a user (e.g., by accessing data submission interface 112), attack vector descriptors 126 at computer vision based security system 102 may access attack vector descriptors 126 and provide these attack vector descriptors 126 for use in descriptor menu 124.

Thus, security anomaly submission interface 114 may provide descriptor menu 124 with attack vector descriptors 126, such as a drop-down or pop-up menu including those attack vector descriptors 126. As such, this descriptor menu 124 may include features already determined by computer vision based security system 102, where those descriptors may be selected by user for inclusion in, or to completely comprise, a textual annotation (e.g., for a corresponding visual annotation). As but one example, such a descriptor menu 124 may be provided at the point of selection of a portion of the image for a visual annotation, or may be provided in a boundary area of a displayed interface, or may be provided via voice instructions to verbally make a selection or dictate a feature.

Security anomaly submission interface 114 can also be adapted to include a free form text entry feature for capturing the user's textual annotation as free form text when the user is not satisfied with attack descriptors in descriptor menu 124, or when the user feels other features that may be expressed in text more accurately describes the user's observations (e.g., associated with a visual annotation). Thus, security anomaly submission interface 114 may be adapted to collect a plurality of observed features for a particular selected region, all of which collectively describe one or more potential anomalies observed in the selected region. Other techniques are possible for the user to provide annotations (either visual or textual), without departing from the spirit of the discussion herein.

Accordingly, users at entities 106 or individual users 108 may utilize security anomaly submission interface 114 to submit anomaly knowledge data through data submission interface 112. This anomaly knowledge data may include an image 132 and one or more associated visual annotations 134 and corresponding textual annotations 136 (e.g., each visual annotation 134, which may be a default visual annotation such as entire image, front of check, back of check, etc. may be associated with a corresponding textual annotation 136). This anomaly knowledge data may be collected into knowledge dataset 138 at computer vision based security system 102 comprising the set of submitted images 132 and associated visual annotations 134 and textual annotations 136.

Thus, as computer vision based security system 102 provides a data submission interface 112 through which anomaly knowledge data may be collected from one or more users at one or more distributed entities 106 or from individual users 108, data on a wide variety of different anomalies may be collected from a wide variety of geographic areas and from a large number of different users who may have differing and wide ranging expertise. For example, a number of fraud analysts and experts may be employed by various entities 106 (e.g., financial institutions) or other organizations across the country or world using documents subject to potentially fraudulent activity. These entities 106 or users 108 may be very diverse, spanning vastly different markets, geographies, and communities. This diversity provides a broad base of expertise. Moreover, this anomaly knowledge may be collected rapidly in knowledge dataset 138 in a (e.g., centralized) location (e.g., knowledge dataset 138) as it is submitted by the users at the entities 106 (or individual users 108).

Using this collected knowledge dataset 138, a set of classification pipelines 148 may be generated. Each classification pipeline 148 may be associated with a particular feature that may be present in an image (e.g., check) and be adapted to determine if an image is anomalous with respect to that feature (e.g., if that feature for that image is indicative of a security violation). Specifically, classification pipeline trainer 168 may generate each of pipelines 148 by training one or more machine learning models based on knowledge dataset 138.

In one embodiment, each pipeline 148 includes a computer vision model trained on the images 132 and visual annotations 134 of knowledge dataset 138 (or a portion thereof) where the computer vision model for a pipeline 148 may be a classification model adapted to make a classification decision for an image indicating of that image is anomalous with respect to that feature. Moreover, in some embodiments, a classification pipeline 148 may include a semantic segmentation model adapted to extract a portion of an image corresponding to the feature of that classification pipeline, such that the computer vision model of that classification pipeline 148 may be applied to the (e.g., portion of the) image extracted by the semantic segmentation model of that classification pipeline 148. This semantic segmentation model may also be trained on the images 132 and visual annotations 134 of knowledge dataset 138 (or a portion thereof).

These classification pipelines 148 may thus be used by computer vision based security system 102 to determine any security violations 184 in submitted images 182 by detecting anomalies in these submitted images 182. Specifically, images 182 (e.g., of checks) may be submitted to computer vision based security system 102 using security determination interface 194 which may be an API or web services interface such as a RESTful interface or the like. This security determination interface 194 may be called, for example, from an application at a user's device such as a baking application including mRDC functionality. For example, such an application may call security determination interface 194 directly from the user's device with an image 182 (e.g., of a check) in a request submitted to security determination interface 194 requesting a security violation determination 184 (e.g., to determine whether a check is fraudulent).

Alternatively or additionally, such an application (e.g., a banking application) may include a frontend executing at a user's device that may call a back end provided by entity 106 with an image 182 (e.g., of a check, to deposit the check or perform a security determination on the check, etc.). This backend application may call security determination interface 194 requesting a security violation determination 184, where that request includes image 182 (e.g., of a check). Users at entities 106 may also have access to a security determination application 162 at entity 106 (or another application that has security determination functionality). For example, tellers or other users at a financial institution may have an application which allows these types of users to submit an image of a check (e.g., received for deposit by the user) for a security determination with respect to the check. These security determination applications 162 may call security determination interface 194 with image 182 (of check) requesting a security violation determination 184.

When computer vision based security system 102 receives a request for such a security violation determination including an image 182 (e.g., of a check), the computer vision based security system 102 may submit the received image 182 to each of classification pipelines 148. Each of the classification pipelines may apply the one or more trained machine learning models of that classification pipeline 148 to make a security determination for that classification pipeline 148 with respect to the submitted image 182. For example, if the classification pipeline 148 includes a semantic segmentation model, the semantic segmentation model of the classification pipeline 148 can be applied to extract a portion of the image. The computer vision model of the classification pipeline 148 may then be applied to the extracted portion of the image (or the entire image) to make a security determination with respect to the image 182. This security determination may include a binary answer indicating an anomaly and thus a security violation (or not), or may be a numerical or other type of score or other numerical indicator indicating a likelihood that the image includes an anomaly, where that numerical indicator may be compared to a threshold to determine if a security violation with respect to that classification pipeline is indicated.

A security violation determination 184 to return in response to a request for a security violation determination may then be made based on the output of each of the classification pipeline 148 (e.g., the security determination made by each of the classification pipelines). For example, some form of combination or weighting may be given to the output of each of the classification pipelines 148 to make an overall security violation determination 184 that is returned to the user (e.g., a binary indicator of a security violation or a score indicating a likelihood of a security violation, etc.). Additionally or alternatively, an indicator which classification pipelines indicated (or did not) indicate a security violation may be returned to a user in a security violation determination 184. These indicators may include, for example, one or more of attack vector descriptors 126.

Specifically, in some embodiments each classification pipeline 148 may be associated with a corresponding one (or more) of attack vector descriptors 126. In particular, attack vector descriptors 126 may be determined by classification pipeline trainer 168 from textual annotations 136 on images 132 as included in knowledge dataset 138. According to one specific embodiment, an attack vector descriptor 126 corresponding to a classification pipeline 148 may be determined in association with training that classification pipelines 148 based on textual annotations 136 associated with the images 132 and visual annotations 134 of knowledge dataset 138 used to train (the machine learning models of) that classification pipeline 148. In this manner, an attack vector descriptor 126 may serve to encapsulate a concept or semantic meaning of a feature or anomaly associated with that classification pipeline 148.

As such, these attack vector descriptors 126 associated with a classification pipeline 148 may serve as a convenient way to provide an explanation of the features that resulted in a security violation being determined. Thus, when a security violation determination 184 that is returned to the user an attack vector descriptor 126 corresponding to each classification pipelines that indicated (or did not) indicate a security violation may be returned to a user in the security violation determination 184 to better allow a user to understand the features or security issues that are problematic with respect to a particular image.

As these attack vector descriptors 126 are associated with a classification pipeline 148, and serve to encapsulate a concept or semantic meaning of a feature or anomaly associated with that classification pipeline 148, these attack vectors 126 may also service as a convenient and useful way to associate newly provided anomaly knowledge with a feature (and corresponding classification pipeline 148) in computer vision based security system 102. To illustrate in more detail, as discussed, when a user at entity 106 or an individual user 108 submits anomaly knowledge data (e.g., an image 132, visional annotation 134 or textual annotation 136) using security anomaly submission interface 114, a descriptor menu 124 including attack vector descriptors 126 may be provided in security anomaly submission interface 114. Thus, a user may utilize this descriptor menu 124 to select one or more attack vector descriptors 126 as a textual annotation 136 for an image 132 and corresponding visual annotation 134 when submitting this anomaly knowledge to computer vision based security system 102.

This attack vector descriptor 126 may thus serve as a mechanism by which incoming submitted anomaly knowledge data may be associated with a particular classification pipeline 148 (e.g., the classification pipeline 148 associated with that attack vector descriptor 126) such that the incoming anomaly knowledge data may be used to perform targeted or focused (re)training of the models of only that classification pipeline 148 (associated with that attack vector descriptor 126). In this manner, only classification models 148 associated with that newly submitted using only that newly submitted anomaly knowledge data may be retrained (e.g., as opposed to having to retrain all classification pipelines 148) and that newly submitted anomaly knowledge data may be rapidly incorporated into classification pipelines 148 to which it is applicable.

In such cases, when the anomaly knowledge data is submitted this newly submitted anomaly knowledge data (e.g., the image 132, visual annotation 134 and textual annotation 136) may be provided to the classification pipeline trainer 168. If the textual annotation 136 is (or includes) an attack vector descriptor 126, the classification pipeline trainer 168 may (re)train only the models of the classification pipeline 148 corresponding to that attack vector 126 based only on that newly submitted anomaly knowledge data (e.g., the image 132 and visual annotation 134). In this manner, as (re)training of the models may be focused solely on a single classification pipeline 148 and using only that particular anomaly knowledge data (e.g., as opposed to (re)training all of classification pipelines 148) a significant amount of time and computing resources may be saved which, additionally, allows this newly acquired anomaly knowledge data to be rapidly incorporated into the classification pipeline 148 and used by computer vision security system 102 in the determination of security violations.

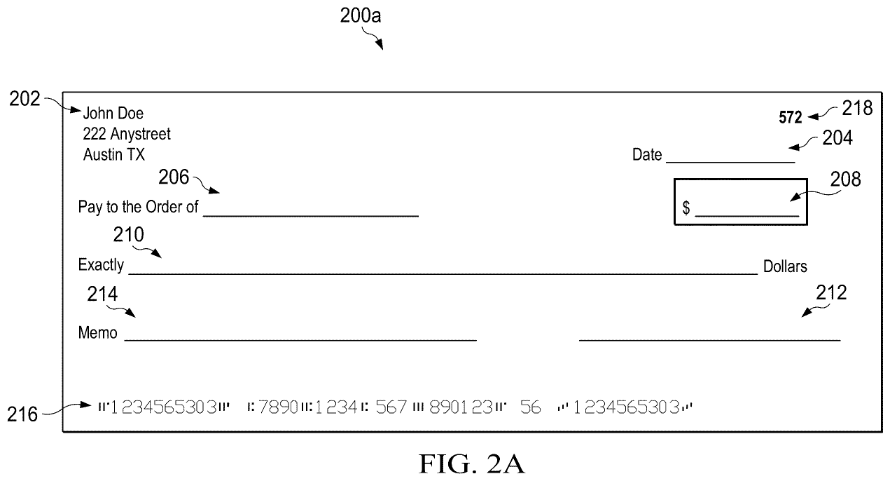

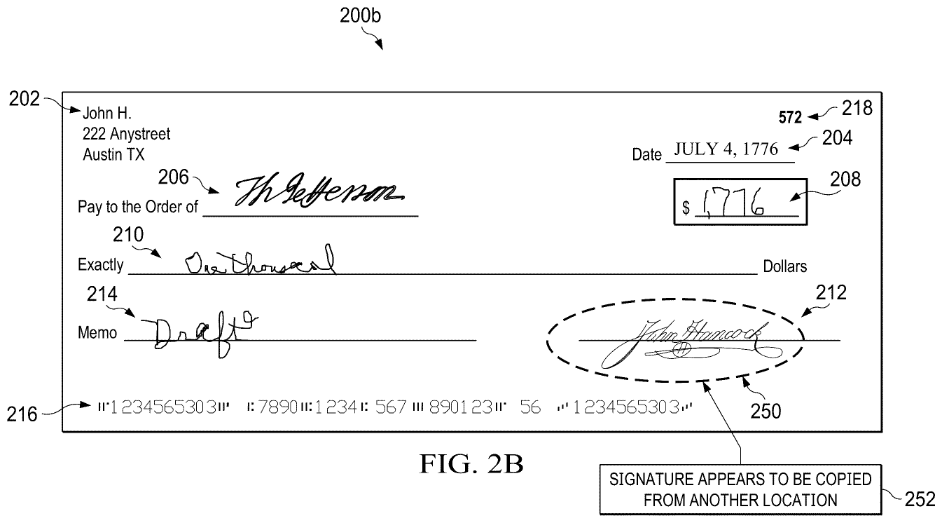

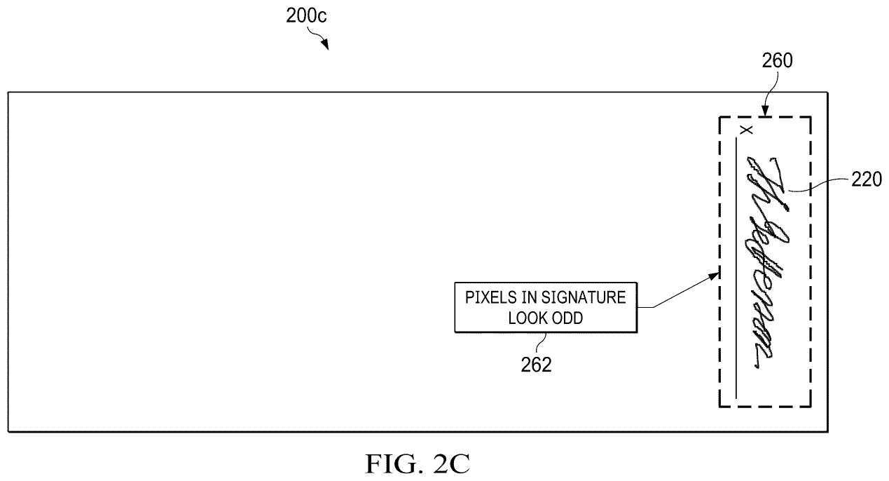

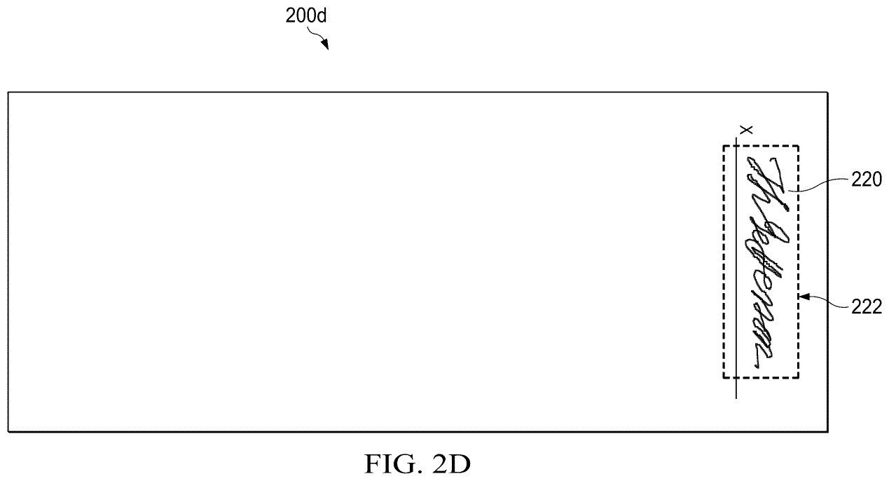

Before describing embodiments further it may be useful to describe examples of features or regions of example images (e.g., of checks) along with a discussion of visual or textual annotations. Referring first to FIG. 2A, an example of an image of a check 300 is depicted. This check 200a includes a printed name section 202, a date field 204, a pay-to field 206, a numeric amount field 208, a written amount field 210, a memo section 214, a signature field 212, a magnetic ink character recognition (MICR) line 216, and a check number 218. Although not shown in FIG. 2A the check 300 may further include, at least, a financial institution name section. The MICR line 216 may typically include, at least, an account number section, a routing number section, and a check number section, printed using magnetic ink in a structured format (e.g., with specific defined delimiters separating the MICR line 316 sections). The routing number may be an American Banking Association (ABA) routing number, which may be considered as coupled with a user's account number to form an ABA-account number pair. Each of these features (or others) may be annotated by a user using a visual annotation and textual annotation.

Visual annotation may include an identification of a complete image of check 300 as indicating a fraudulent anomaly, in which case regions may not be further identified. Visual annotation may also include identifying a specific sub-region or portion of an image 300. Textual annotation may comprise providing a (e.g., natural language) textual annotation corresponding to the entire check 300 or a particular visual annotation. For example, a user may annotate the complete image as “image of check taken off computer screen” or “image taken off laptop.” As another example, the user may annotate the complete image as having a feature “computer screen background.”

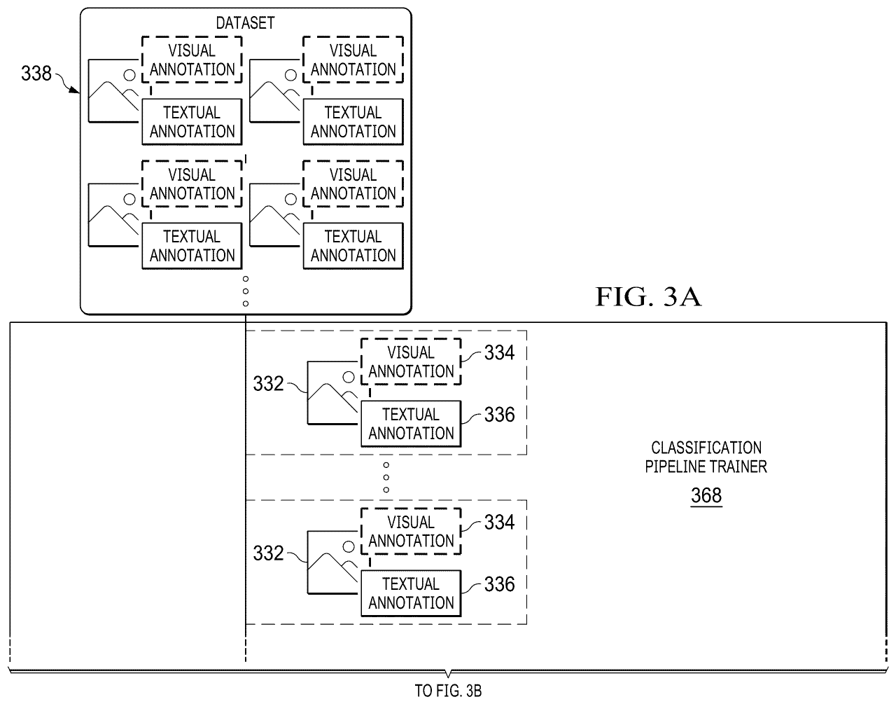

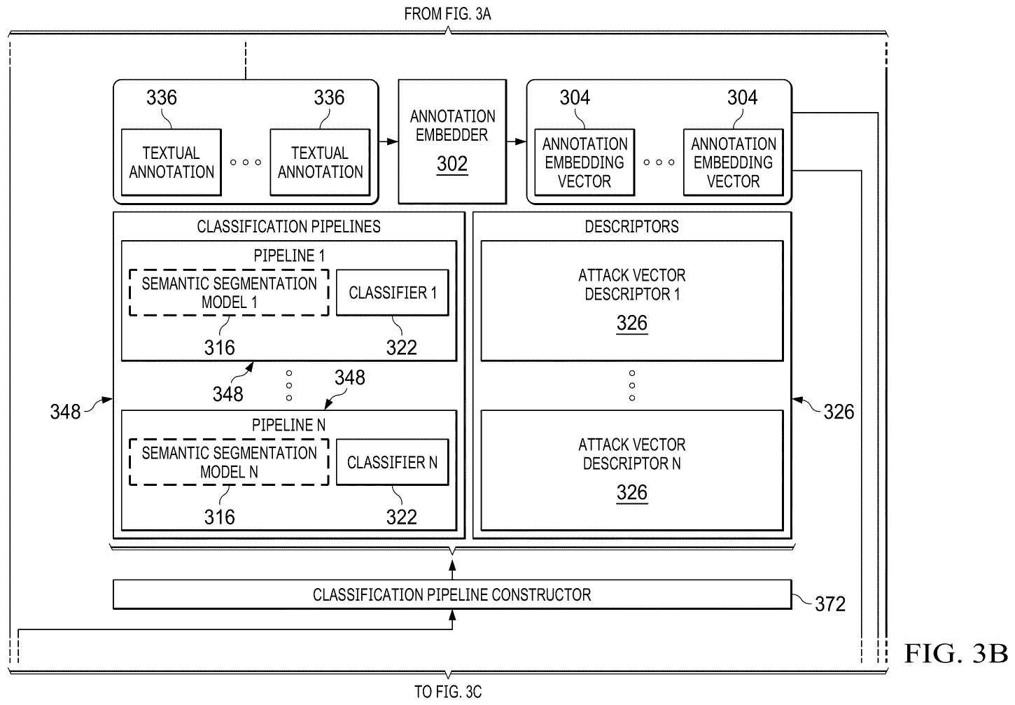

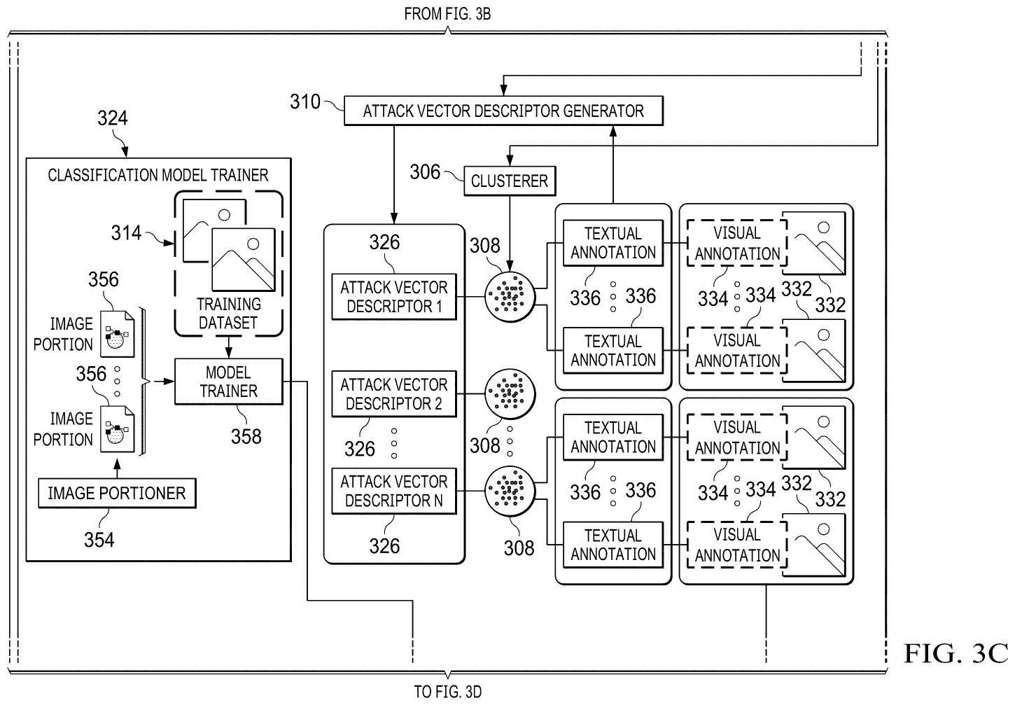

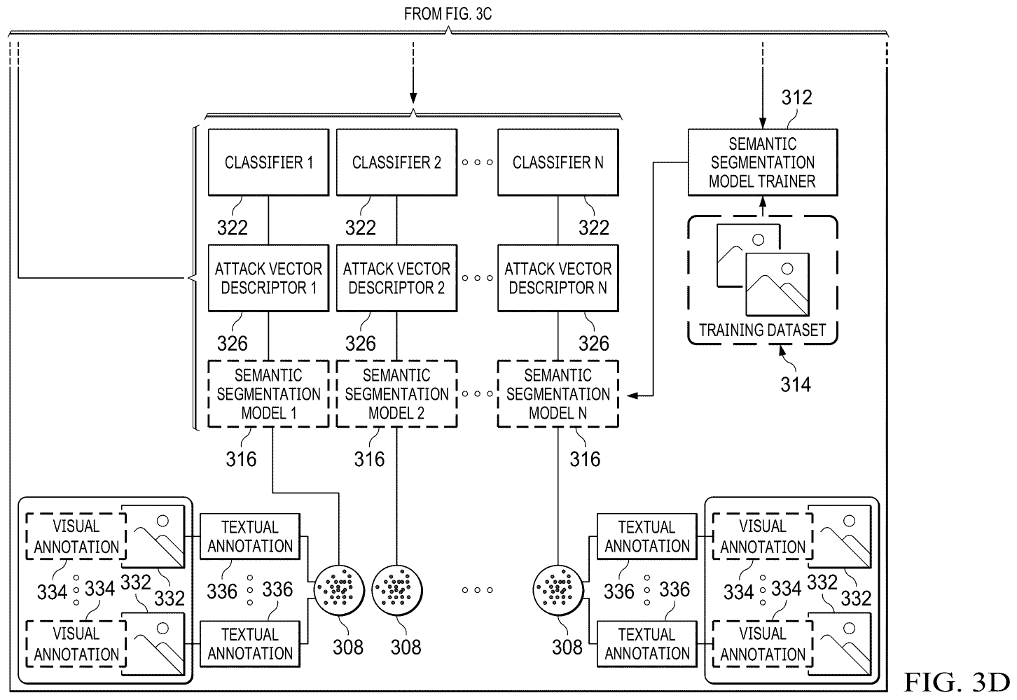

FIG. 2B is an example of a check 200b in a where the user has provided a visual annotation 250 and corresponding textual annotation 252 (e.g., associated with signature field 212). Such annotations may be provided, for example, through a security anomaly submission interface as discussed. FIG. 2C is an example of a reverse side of a check 200c where the user has provided a visual annotation 250 and corresponding textual annotation for an endorsement section 220 of check 200c. FIG. 3D is another example of the reverse side of a check 200d illustrating a visual annotation 222 that isolates the handwritten signature of the endorsement section 220 of the check 200d. Again this isolated handwritten signature of the endorsement section 220 may be selected and textually annotated by a user. For example, the user may annotate with a text indicating “signature appears to be copied and pasted” or “signature has capital letter with unusual loop” or “signature similar to previously seen fraudulent signature.”

Moving now to FIG. 3, one embodiment of a classification pipeline trainer for generating one or more classification pipelines is depicted. Classification pipeline trainer 368 may be adapted to train a set of classification pipelines 348 based on knowledge dataset 338 comprising a set of images 332 (e.g., of checks), where each image 332 is associated with a visual annotation 334 (which may be a default annotation specifying the entire image 332) and a corresponding textual annotation 336 associated with that visual annotation 334.

Initially, to train these classification pipelines 348, the textual annotations 336 for each data point (e.g., an image 332 with a visual annotation 334 and corresponding textual annotation 336) in data set 338 may be provided to an annotation embedder 302 which embeds each textual annotation 336 to generate annotation embedding vectors 304 for each textual annotation 336. Embedding is a method of converting discrete objects (sets of text) into points within a space and serves to quantify or categorize semantic similarities between linguistic items based on their distributional properties in large samples of language data. The spatial encoding thus represents important characteristics of the objects (e.g. objects close to one another may be semantically similar.).

In one embodiment, annotation embedder 302 may use a (e.g., pre-trained) neural language model (e.g., a neural network trained to perform embedding on linguistic data). Such a neural language model may be adapted to map text onto a compact mathematical representation known as an embedding (or vector) in a vector space. For any input textual annotation 336, then, the corresponding annotation embedding vector 304 generated by the neural language model may capture the semantic or syntactic characteristics of that textual annotation 336. Accordingly, in some embodiments to generate a single mathematical representation for a textual annotation 336, the neural language model may be applied to each term of the textual annotation 336 to generate a corresponding embedding for each term. These embeddings can then be combined (for example, summed) to generate a single mathematical representation for the textual annotation 336 based on the embeddings associated with each term of the textual annotation 336.

In some embodiments, before the embeddings for each term are combined, or to create the embeddings, each of the embeddings may be manipulated or created using other data such as an inverse document frequency associated with the term. In particular, in one embodiment, each of the embeddings (vectors) may utilize a scalar factor (e.g., IDF value) for the corresponding term to generate, or otherwise manipulate, an embedding to generate the single mathematical representation for the textual annotation 336.

Other techniques for embedding may also be utilized. For example, the annotation embedder 302 may include or reference a repository of cross-lingual word embedding vectors such as the FastText embeddings provided by Project Muse (Multilingual Unsupervised and Supervised Embeddings). Other types of embeddings may also be utilized without loss of generality, including for example neural network based embedding, Word2Vec, GloVE, BERT, ELMO or the like).

Embodiments may thus embed textual annotation 336 (e.g., as n-dimensional vectors) to generate annotation embedding vectors 304. In this manner, regardless of the language of the textual annotations 336 those textual annotations 336 can be converted to a common (e.g., numerical) representation of the semantics of the topics or concepts of each textual annotation 336 regardless of the language or syntax utilized in the textual annotation 336. Specifically, embedding may advantageously capture rich semantic and syntactic features from the original text of each annotation 336, enabling conclusions to be inferred about the similarity of two unrelated annotations 336, even these annotations 336 may very different language to describe (e.g., similar) observations. Another potential advantage afforded by embedding is mathematical. Because the embedding domain may be a vector space, well-defined mathematical measures of similarity may be used to precisely define the “distance” between two distinct annotations

In particular, as these embedding approaches tend to place annotation embedding vectors 304 from one textual annotation 336 in a location within the embedding space close to other annotation embedding vectors 304 generated from textual annotations 336 with a similar meaning, these annotation embedding vectors 304 may be leveraged to group textual annotations 336 with similar meanings. According to one embodiment, therefore, once annotation embedding vectors 304 are generated from textual annotations 336, these annotation embedding vectors 304 may be provided to clusterer 306, where clusterer 306 is adapted to generate clusters 308 by clustering these annotation embedding vectors 304.

Clusterer 308 may accomplish this clustering utilizing almost any clustering tools or methodology desired, including, for example, hierarchical clustering, density-based spatial clustering of applications with noise (DBSCAN), k-means clustering, agglomerative clustering, or convex clustering. These generated clusters 308 may thus be defined by a resulting cluster of annotation embedding vectors 304. As such, each of the generated clusters 308 may be associated with the data items of dataset 338 that include the textual annotations 336 of that cluster 308 corresponding to the annotation embedding vectors 304 comprising that cluster 308, including the textual annotations 336 corresponding to each of the annotation embedding vectors 304 comprising that cluster (e.g., from which those annotation embedding vectors 304 were generated), and visual annotations 334 and images 332 associated with those textual annotations 336.

The textual annotations 336 associated with each of the clusters 308 can then be provided to attack vector descriptor generator 310 to generate attack vector descriptors 326 associated with each cluster 308. This attack vector descriptor 326 for a cluster 308 can thus represent the concepts or semantic meanings indicated in the textual annotations 336 associated with the cluster 308. In one embodiment, to generate an attack vector descriptor 326 associated with a cluster 308, the attack vector descriptor generator 310 may include a Large Language Model (e.g., a foundational of generative LLM). This LLM may be adapted to summarize text. The LLM may be used to provide a concise single or several-word description of the feature contained therein, for example using one or more prompts. The provided description from the LLM may be used as the attack vector descriptor 326 for that cluster 308.

In one embodiment, then, to generate the attack vector descriptor the attack vector descriptor generator 310 may submit the textual annotations 336 associated with that cluster 308 to the LLM with a prompt to generate a (e.g., 1-4) word textual description summarizing the concepts of the submitted textual annotations 336. Other mechanisms for generating such attack vector descriptors from textual annotations 336 may also be utilized such as, for example, extracting terms or text from these textual annotations 336 and scoring and ranking such extracted terms or text.

A semantic segmentation model 316 associated with each of the clusters 308 may also be generated, if needed, from the images 332 and visual annotations 334 associated with a cluster 308. A semantic segmentation model 316 for a cluster 308 may be adapted to identify and extract a portion of the image corresponding to the cluster 308. In one embodiment, therefore, semantic segmentation model trainer 312 may determine that a semantic segmentation model 316 is needed for a cluster 308 if at least one visual annotation (or a certain number of visual annotations for the cluster 308) specify a bounding shape or specify a portion of an image 332 less than the entire image 332. This semantic segmentation model 316 may then be trained for a cluster 308 based on each of the images 332 associated with the cluster 308 along with the associated visual annotations 334 for each of those images 332 associated with the cluster 308.

In one embodiment, this semantic segmentation model 316 may be a computer vision machine learning model, such as a neural network, adapted to perform image segmentation (e.g., assigning a label to a group of one or more pixels of an image). To train the semantic segmentation model 316, semantic segmentation model trainer 312 may use a positive dataset comprising the images 332 associated with the cluster 308 along with the associated visual annotations 334 for each of those images 332. A negative dataset comprising a random sample of (e.g., check) images from a corpus 314 of (e.g., check) images may be generated, where there may be a certain confidence the images of this negative dataset are not of the class. Moreover, this negative dataset may include a randomly generated visual annotation for each image of the negative training dataset. These randomly generated visual annotations may comprise random bounding shapes that may be within some threshold of size (e.g., greater than a certain size or less than a certain size).

Classification pipeline trainer 368 may also include classification model trainer 324 adapted to generate a classifier (or other type of machine learning model) 322 associated with each cluster 308. Each classifier 322 may be a computer vision-based classifier (e.g., a neural network) adapted for detecting the presence of the features defined by the images 322 and corresponding visual annotations 334 associated with a cluster 308. Specifically, classifier 322 may be a Boolean classifier that detects the presence (or absence) of the described feature.

Thus, in one embodiment, a computer vision based classifier 322 for a cluster 308 may be trained by classification model trainer 324 based on the images 332 and visual annotations 334 associated with that cluster 308. In particular, the images 332 and visual annotations 334 may be provided to image portioner 354 which may extract the portion 356 of each image 332 defined by the associated visual annotation 334 (again, this portion 356 may be defined as the entire image or some portion less than the entire image 332). Each of these extracted image portions 356 may be provided to model trainer 358 which trains a computer vision based classifier 322 based on those image portions 356 where the classifier may be adapted to generate an output indicating a presence (or absence) of a feature (e.g., anomaly) present in those extracted portions 356. This output may be a Boolean value, a likelihood, or some other indicator. For example, one or several of a variety transformer-based computer vision models or trainers may be utilized, such as Vision Transformer (ViT), Detection Transformer (DETR), or Convolutional vision Transformer (CvT) may be employed.

In some embodiments, these classifiers 322 may be trained using a (e.g., disjoint) train, test, or cross-validation set. Thus, in one embodiment, to train the computer vision based classifier 322, model trainer 358 may use a positive dataset comprising the image portions 356 extracted from images 332 associated with the cluster 308. A negative dataset comprising randomly extracted portions of (e.g., check) images from a corpus 314 of (e.g., check) images, where there may be a certain confidence the extracted portions of the images of this negative dataset do not include the feature (e.g., anomaly). These randomly extracted portions may be within some threshold of size (e.g., greater than a certain size or less than a certain size).

At this point, then, classification pipeline generator 368 may have generated a classifier 322 and attack vector descriptor 326 for each cluster 308. There may also be a semantic segmentation model 316 associated with one or more of the clusters 308. Accordingly, classification pipeline trainer 368 may also include classification pipeline constructor 372 adapted to generate a set of classification pipelines 348 for deployment in association with a computer vision based security system. Each of these classification pipelines 348 may be associated with a cluster 308 (e.g., include the classifier 322 and any semantic segmentation model 316 associated with that cluster 308). Additionally, then, each classification pipeline 348 may be associated with an attack vector descriptor 326 generated based on that same cluster 308.

Each classification pipeline 348 may comprise a classifier 322 associated with a particular cluster 308 and any semantic segmentation model 316 associated with that cluster 308. The classification pipeline 348 may thus be adapted to receive an image, apply a semantic segmentation model 316 of the pipeline 348 (if one is included in the pipeline 348) to extract an image portion from the received image and apply the classifier 322 of the classification pipeline 348 to make a security determination for that classification pipeline 348 with respect to the submitted image.

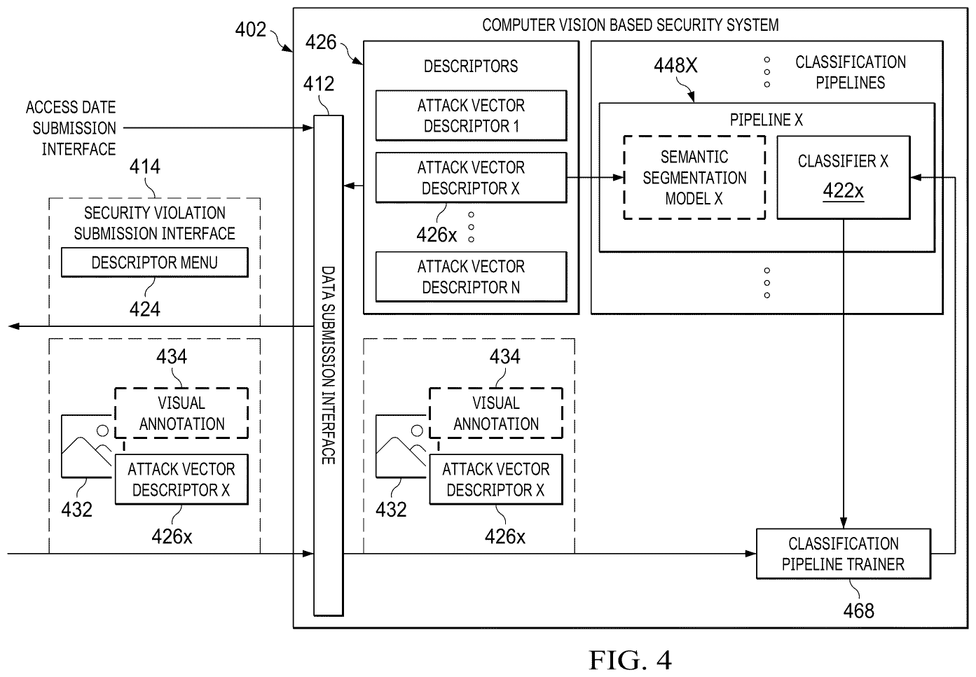

As attack vector descriptors are associated with individual classification pipelines, these attack vectors may also serve as a convenient and useful way to associate newly provided anomaly knowledge with a classification pipeline in order to retrain that classification pipeline (e.g., while avoiding retraining other classification pipelines). FIG. 4 is a block diagram depicting one embodiment of the retraining of a classification pipeline in a computer vision based security system based on anomaly knowledge data associated with an attack vector descriptor. When a user accesses security anomaly submission interface 414, a descriptor menu 424 including attack vector descriptors 426 may be provided in security anomaly submission interface 414. Thus, a user may utilize this descriptor menu 424 to select one or more attack vector descriptors 426 as a textual annotation 436 for an image 432 and corresponding visual annotation 434 when submitting this anomaly knowledge to computer vision based security system 402.

When this anomaly knowledge data (a new data item) including textual annotation 436 comprising the attack vector descriptor 426x for image 432 and corresponding visual annotation 434 is submitted it may be received by data submission interface 412 and provided to classification pipeline trainer 468. Based on the attack vector descriptor 426x included as textual annotation 436, the submitted anomaly knowledge data may be associated with the classification pipeline 448x associated with that attack vector descriptor 426x such that the incoming anomaly knowledge data (the incoming new data item) may be used to perform targeted or focused (re)training of the models of only that classification pipeline 448x (associated with that attack vector descriptor 426x). In this manner, only classification model 422x associated with the attack vector descriptor 426x included in the (new) anomaly knowledge data may be (re)trained using only that newly submitted anomaly knowledge data (data item) such that the submitted anomaly knowledge data may be rapidly incorporated into classification pipeline 448x to which it is applicable.

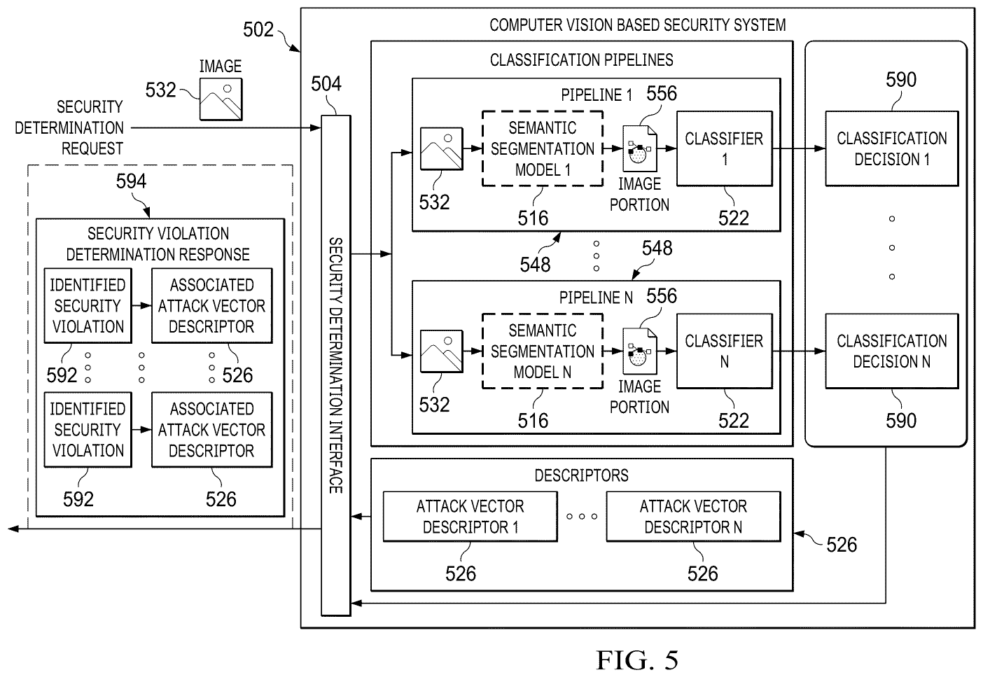

FIG. 5 is a block diagram depicting one embodiment of the application and use of classification pipelines in making a security violation determination in a computer vision based security system. When a computer vision based security system receives a request for such a security violation determination including an image 532 (e.g., of a check) through security determination interface 504, the computer vision based security system may submit the received image 532 to each of classification pipelines 548. Each of the classification pipelines 548 may apply the classifier model 522 of that classification pipeline 548 to make a security determination 590 (e.g., classification decision) for that classification pipeline 548 with respect to the submitted image 532. For example, if the classification pipeline 548 includes a semantic segmentation model 516, the semantic segmentation model 516 of the classification pipeline 548 can be applied to extract a portion 556 of the image 532. The computer vision classifier model 522 of the classification pipeline 548 may then be applied to the extracted portion 556 of the image (or the entire image) to make a security determination 590 with respect to the image 532.

A security violation determination response 584 to return in response to a request for a security determination may then be made based on the output of each of the classification pipeline 548 (e.g., the security determination made by each of the classification pipelines). For example, such a security violation determination response 584 may indicate that a submitted image of a check may be fraudulent (or include one or more instances of fraud).

An indicator 592 of which classification pipelines 548 indicated (or did not) indicate a security violation may also be returned to a user in a security determination response 584. These indicators 592 may be associated with one or more of attack vector descriptors 526. According to one specific embodiment, the security violation determination response 584 that is returned to the user may include an attack vector descriptor 526 corresponding to each classification pipeline 548 that indicated (or did not) indicate a security violation to better allow a user to understand the features or security issues that are problematic with respect to a particular image.

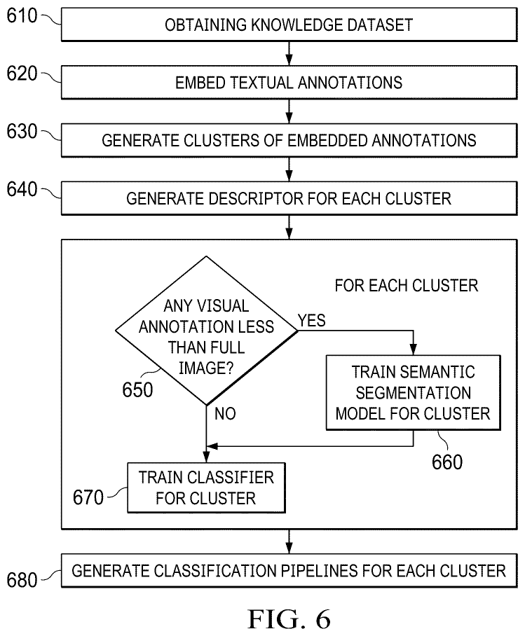

Referring now to FIG. 6, a flow diagram for one embodiment of a method of generating classification pipeline at a computer vision based security system is depicted. Initially a knowledge dataset comprising data items may be obtained (STEP 610). Each data item of the knowledge dataset may comprise an image, a visual annotation, and a textual annotation. These textual annotations of the data items of the knowledge dataset may be embedded to generate annotation embedding vectors for each of the textual annotations of the data items (STEP 620).

The annotation embedding vectors generated from the textual annotations may be clustered to generate a set of clusters of these embedded annotations (STEP 630). Thus, each of the generated clusters may be associated with a corresponding set of data items of the knowledge data set. An attack vector descriptor associated with each cluster may be generated (STEP 640). This attack vector descriptor for a cluster may be generated based on the textual annotations of the set of data items corresponding to that cluster and expresses a concept associated with those textual annotations. This attack vector descriptor can be generated using, for example, an LLM.

For each cluster, it can be determined if a visual annotation associated with the data items of that cluster comprises an annotation specifying any portion of an image less than the full image of that data item (STEP 650). If so (Y Branch of STEP 650), a semantic segmentation model may be trained for that cluster based on the images and visual annotations of the set of data items corresponding to that cluster (STEP 660). Additionally, a computer vision based machine learning model (e.g., a classifier) may be trained for each cluster (STEP 670). The computer vision based machine learning model for a cluster is trained based on the images and visual annotations of the set of data items corresponding to that cluster. At this point, a set of classification pipelines may be generated based on each cluster (STEP 680). Each classification pipeline may comprise the computer vision based model trained for the associated cluster along with the semantic segmentation model trained for that cluster if it exists.

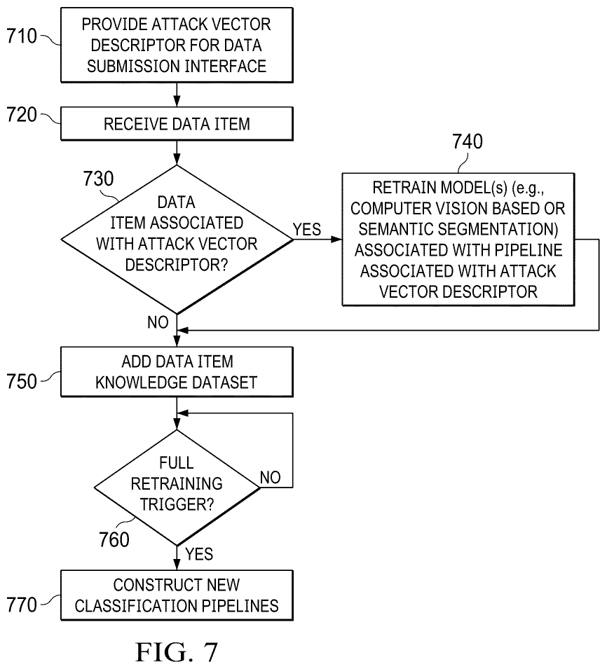

FIG. 7 is a flow diagram for one embodiment of a method of retraining the classification pipelines utilized by a computer vision based security system. In embodiments of such a computer vision based security system, attack vector descriptors associated with the classification pipelines of the computer vision based security system may be provided in a data submission interface of the computer vision based security system (STEP 710). Thus, when a data item (image, textual annotation and any visual annotation) is received (STEP 720), it can be determined if that data item is associated with an attack vector descriptor (STEP 730).

If the newly received data item is associated with an attack vector descriptor (Y Branch of STEP 730), the classification pipeline associated with this new data item can be determined based on the associated attack vector descriptor. The computer vision based machine learning model (e.g., or the semantic segmentation model) associated with that classification pipeline can then be retrained based on this newly received data item (STEP 740). If the newly received data item is not associated with an attack vector descriptor (N Branch of STEP 730), the new data item may just be added to the knowledge dataset (STEP 750). At some point then (e.g., based on time, an amount of data, etc.) a full training trigger may occur (Y Branch of STEP 760). At this point, a new set of classification pipelines may occur based on the accumulated knowledge dataset (STEP 770).

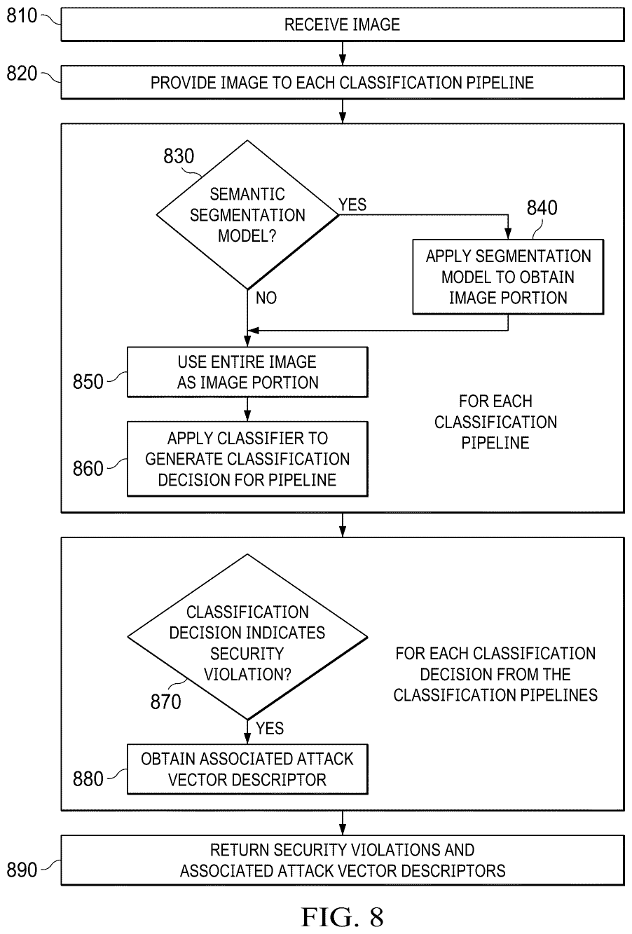

Moving on to FIG. 8, one embodiment of a method for making a security violation determination in a computer vision based security system is depicted. Here, computer vision based security systems may receive an image (STEP 810). This image may be received, for example in a request for a security violation determination. The computer vision based security system may provide the received image to each of classification pipelines (STEP 820). Each of the classification pipelines may apply the one or more trained machine learning models of that classification pipeline to make a security determination for that classification pipeline with respect to the submitted image.

Specifically, if a classification pipeline includes a semantic segmentation model (Y Branch of STEP 830), the semantic segmentation model of the classification pipeline can be applied to extract a portion of the image (STEP 840), otherwise the entire image may be utilized (STEP 850). The computer vision model of the classification pipeline (e.g., the classifier) may then be applied to the extracted portion of the image (or the entire image) to make a security determination (e.g., a classification decision) with respect to the image (STEP 860). This security determination may include a binary answer indicating an anomaly and thus a security violation (or not), or may be a numerical or other type of score or other numerical indicator indicating a likelihood that the image includes an anomaly, where that numerical indicator may be compared to a threshold to determine if a security violation with respect to that classification pipeline is indicated.

A security violation determination to return in response to a request for a security violation determination may then be made based on the output of each of the classification pipelines. In one embodiment, for each classification pipeline that returned an indication of a security violation an associated attack vector may be obtained (Y Branch of STEP 870 and STEP 880). The security violation determination may thus include an indicator which classification pipelines indicated (or did not) indicate a security violation along with the corresponding attack vector for that classification pipeline. This security violation determination may then be provided to a user (STEP 890).

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. A “computer-readable medium” may be any type of data storage medium that can store computer instructions that are translatable by a processor. Examples of computer-readable media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like. Data may be stored in a single storage medium or distributed through multiple storage mediums, and may reside in a single database or multiple databases (or other data storage).

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any particular routine can be executed on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit CPU or other processor, memory (e.g., primary or secondary memory such as RAM, ROM, HD or other computer readable medium for the persistent or temporary storage of instructions and data) and an input/output (“I/O”) device. The I/O device can include a keyboard, monitor, printer, electronic pointing device (for example, mouse, trackball, stylus, etc.), touch screen or the like. In embodiments, the computer has access to at least one database on the same hardware or over the network.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within a claim otherwise. Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the figures can also be implemented in a more separated or integrated manner, or even removed or rendered as inoperable in certain cases, as is useful in accordance with a particular application. Additionally, any signal arrows in the figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

In the foregoing specification, the invention has been described with reference to specific embodiments. However, one of ordinary skill in the art appreciates that various modifications and changes can be made without departing from the scope of the invention. Accordingly, the specification, including the Summary, Abstract and figures are to be regarded in an illustrative rather than a restrictive sense, and all such modifications are intended to be included within the scope of invention.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine-readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

What is claimed is:

1. A method, comprising:
obtaining a knowledge dataset comprising data items, each data item of the knowledge dataset comprising an image, a visual annotation, and a textual annotation;
embedding textual annotations of the data items of the knowledge dataset to generate annotation embedding vectors for each of the textual annotations of the data items;
clustering the annotation embedding vectors of the textual annotations to generate a set of clusters, each cluster associated with a corresponding set of data items of the knowledge data set;
training a computer vision based machine learning model based on each cluster, wherein the computer vision based machine learning model for a cluster is trained based on images and visual annotations of the set of data items corresponding to that cluster;
generating a set of classification pipelines based on each cluster, each classification pipeline comprising the computer vision based model trained for an associated cluster;
receiving an image; and
applying the set of classification pipelines to the image to make a security violation determination with respect to the image.

2. The method of claim 1, further comprising training a semantic segmentation model associated with each of one or more clusters, wherein the semantic segmentation model for the cluster is trained based on images and visual annotations of the set of data items corresponding to that cluster, and wherein the classification pipelines associated with each of the one or more clusters comprises the semantic segmentation model associated that cluster.

3. The method of claim 1, wherein the visual annotation is a bounding shape.

4. The method of claim 1, wherein the textual annotation is in natural language.

5. The method of claim 1, further comprising determining an attack vector descriptor associated with each classification pipeline based on each cluster, wherein the attack vector descriptor for the cluster is generated based on the textual annotations of the set of data items corresponding to that cluster and expresses a concept associated those textual annotations.

6. The method of claim 5, wherein the attack vector descriptors are generated by providing a prompt and the textual annotations to a large language model

7. The method of claim 5, further comprising:
receiving a new data item, wherein the new data item is associated with a first attack vector descriptor;
determining the classification pipeline associated with the new data item based on the first attack vector descriptor; and
retraining only the computer vision based machine learning model of the classification pipeline associated with the new data item, wherein the computer vision based machine learning model is retrained based on the new data item.

8. A system, comprising:
a processor;
a data store comprising a knowledge dataset comprising data items, each data item of the knowledge dataset comprising an image, a visual annotation, and a textual annotation;
a non-transitory computer readable medium, comprising instructions for:
embedding textual annotations of the data items of the knowledge dataset to generate annotation embedding vectors for each of the textual annotations of the data items;
clustering the annotation embedding vectors of the textual annotations to generate a set of clusters, each cluster associated with a corresponding set of data items of the knowledge data set;
training a computer vision based machine learning model based on each cluster, wherein the computer vision based machine learning model for a cluster is trained based on images and visual annotations of the set of data items corresponding to that cluster;
generating a set of classification pipelines based on each cluster, each classification pipeline comprising the computer vision based model trained for an associated cluster;
receiving an image; and
applying the set of classification pipelines to the image to make a security violation determination with respect to the image.

9. The system of claim 1, wherein the non-transitory computer readable medium comprises instructions for training a semantic segmentation model associated with each of one or more clusters, wherein the semantic segmentation model for the cluster is trained based on images and visual annotations of the set of data items corresponding to that cluster, and wherein the classification pipelines associated with each of the one or more clusters comprises the semantic segmentation model associated that cluster.

10. The system of claim 8, wherein the visual annotation is a bounding shape.

11. The system of claim 8, wherein the textual annotation is in natural language.

12. The system of claim 8, wherein the non-transitory computer readable medium comprises instructions for determining an attack vector descriptor associated with each classification pipeline based on each cluster, wherein the attack vector descriptor for the cluster is generated based on the textual annotations of the set of data items corresponding to that cluster and expresses a concept associated those textual annotations.

13. The system of claim 12, wherein the attack vector descriptors are generated by providing a prompt and the textual annotations to a large language model

14. The system of claim 12, wherein the non-transitory computer readable medium comprises instructions for:
receiving a new data item, wherein the new data item is associated with a first attack vector descriptor;
determining the classification pipeline associated with the new data item based on the first attack vector descriptor; and
retraining only the computer vision based machine learning model of the classification pipeline associated with the new data item, wherein the computer vision based machine learning model is retrained based on the new data item.

15. A non-transitory computer readable medium, comprising instructions for:
obtaining a knowledge dataset comprising data items, each data item of the knowledge dataset comprising an image, a visual annotation, and a textual annotation;
embedding textual annotations of the data items of the knowledge dataset to generate annotation embedding vectors for each of the textual annotations of the data items;
clustering the annotation embedding vectors of the textual annotations to generate a set of clusters, each cluster associated with a corresponding set of data items of the knowledge data set;
training a computer vision based machine learning model based on each cluster, wherein the computer vision based machine learning model for a cluster is trained based on images and visual annotations of the set of data items corresponding to that cluster;
generating a set of classification pipelines based on each cluster, each classification pipeline comprising the computer vision based model trained for an associated cluster;
receiving an image; and
applying the set of classification pipelines to the image to make a security violation determination with respect to the image.

16. The non-transitory computer readable medium of claim 15, further comprising instructions for: training a semantic segmentation model associated with each of one or more clusters, wherein the semantic segmentation model for the cluster is trained based on images and visual annotations of the set of data items corresponding to that cluster, and wherein the classification pipelines associated with each of the one or more clusters comprises the semantic segmentation model associated that cluster.

17. The non-transitory computer readable medium of claim 15, wherein the visual annotation is a bounding shape.

18. The non-transitory computer readable medium of claim 15, wherein the textual annotation is in natural language.

19. The non-transitory computer readable medium of claim 15, further comprising instructions for: determining an attack vector descriptor associated with each classification pipeline based on each cluster, wherein the attack vector descriptor for the cluster is generated based on the textual annotations of the set of data items corresponding to that cluster and expresses a concept associated those textual annotations.

20. The non-transitory computer readable medium of claim 19, wherein the attack vector descriptors are generated by providing a prompt and the textual annotations to a large language model

21. The non-transitory computer readable medium of claim 19, further comprising instructions for:
receiving a new data item, wherein the new data item is associated with a first attack vector descriptor;
determining the classification pipeline associated with the new data item based on the first attack vector descriptor; and
retraining only the computer vision based machine learning model of the classification pipeline associated with the new data item, wherein the computer vision based machine learning model is retrained based on the new data item.
